(19) United States
(12) Patent Application Publication
(10) Pub. No.: US 2016/0245519 A1
(43) Pub. Date: Aug. 25, 2016

(54) PANEL WITH COOLING HOLES AND METHODS FOR FABRICATING SAME

(71) Applicant: UNITED TECHNOLOGIES CORPORATION, Farmington, CT (US)

(72) Inventor: Steven W. Burd, Cheshire, CT (US)

(21) Appl. No.: 15/030,222

(22) PCT Filed: Aug. 21, 2014
(86) PCT No.: PCT/US14/52066

§ 371 Date: Apr. 18, 2016

Related U.S. Application Data
(60) Provisional application No. 61/893,107, filed on Oct. 18, 2013.

(51) Int. Cl. F23R 3/06; G05B 19/4099; B29C 67/00; F23R 3/00; F02C 7/18

(52) U.S. Cl. CPC F23R 3/06; F23R 3/002; F02C 7/18; B29C 67/0088; G05B 19/4099; F05D 2230/50; F05D 2240/35; F05D 2260/202; F05D 2300/10; F05D 2230/31; G05B 2219/35134; G05B 2219/49007; B33Y 50/02

(57) ABSTRACT

A gas turbine engine component and a method for forming a component with a plurality of apertures are provided. An additive metal manufacturing process for fabricating a component with apertures includes receiving data including a three-dimensional representation of the component, generating an electronic file based on the received data, wherein the electronic file includes fabrication instructions for entire portions of the component, and forming initial and additional portions of the component based on the electronic file.

### CROSS-REFERENCE TO RELATED APPLICATION

This application claims the benefit of and priority to U.S. Provisional Patent Application No. 61/893,107, filed 18 Oct. 2013, which is hereby incorporated by reference in its entirety.

### FIELD

The present disclosure relates generally to gas turbine engine components, and more particularly, to gas turbine engine components with apertures including effusion cooling holes and methods for fabricating same using additive metal manufacturing techniques.

### BACKGROUND

The temperature in a gas turbine engine can easily exceed the melting temperature of metal components. Cooling holes, often termed film or effusion cooling holes, are employed to provide an air barrier for surfaces exposed to high temperatures.

Cooling holes are typically introduced to a component in a separate operation after the component is initially fabricated without them. Such separate operations can lead to added cost and time for manufacture. Typically, cooling holes are introduced subsequently with lasers, electro-discharge machining, or other machining techniques. A drawback of these techniques may be the introduction of laser slags or structural debits in a part due to the laser drilling.

In some cases, conventional techniques do not allow for cooling holes to be drilled due to drilling limitations of the techniques utilized, inability to gain access to a drilling location, etc. In addition, conventional drilling techniques may limit the design of parts or components. In other cases, it is not practical to form the cooling holes to provide sufficient cooling with conventional techniques.

### SUMMARY

Disclosed and claimed herein are components and methods for fabricating a component with apertures for fluid passages or effusion cooling holes. According to an embodiment, a method for fabricating a component with apertures includes additive manufacturing initial and additional portions of a component based on data of at least one electronic file representative of the component with the initial and additional portions defining at least a portion of an aperture therethrough, wherein an exit portion of the aperture formed by the additive manufacturing has a wider diameter than that of other portions of the aperture.

According to an embodiment, a method for fabricating a component with cooling passages is disclosed. The method includes receiving data including a three-dimensional (3D) representation of a component, and generating a 3D computer-aided design (CAD) file based on the receiving data, wherein the generated 3D CAD file includes fabricating instructions for all features of the component with a plurality of apertures. The method further includes forming an initial portion of the component by an additive metal manufacturing process based on the 3D CAD file containing fabrication instructions for the initial portion of the component, and further forming an additional portion of the component by the additive metal manufacturing process based on the 3D CAD file containing fabrication instructions for the additional portion of the component, wherein the additional portion is formed on the initial portion, and wherein a portion of at least one aperture of the component is formed by the initial portion and the additional portion, and an exit portion of the aperture produced by the additive metal manufacturing process has a wider diameter than that of other portions of the aperture.

Another aspect of the disclosure is directed to a gas turbine engine component including a solid metal structure formed by an additive metal manufacturing process, wherein the component includes a plurality of apertures and an exit portion of the apertures produced by the additive metal manufacturing process has a wider diameter than that of other portions of the aperture to efficiently provide an air barrier along surfaces exposed to high temperature.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify corresponding features throughout, and wherein:

FIG. 1 depicts a method for fabricating a component according to one or more embodiments;

FIG. 2 depicts a method for fabricating a component according to one or more embodiments;

FIG. 3A illustrates a graphical representation of a component according to one or more embodiments; and

FIGS. 3B-3C depict cross-sectional views of a component according to one or more embodiments.

### DETAILED DESCRIPTION

In view of the problems with the conventional techniques, it is desirable to manufacture components with cooling passages built from scratch as opposed to subsequently forming cooling passages using a base part.

One aspect of the disclosure relates to fabricating a component including one or more cooling passages by an additive metal manufacturing process. As used herein, a component may include, for example, one or more of a combustor panel, a combustor liner, a combustor component, a double walled component, and a gas turbine engine component.

According to one aspect of the present disclosure, such component may be fabricated to define one or more cooling passages or apertures using additive manufacturing techniques. Fabrication of the component by an additive process allows for formation of cooling passages during component formation. As such, drilling or machining cooling holes in the component may not be required or needed after a component if formed.

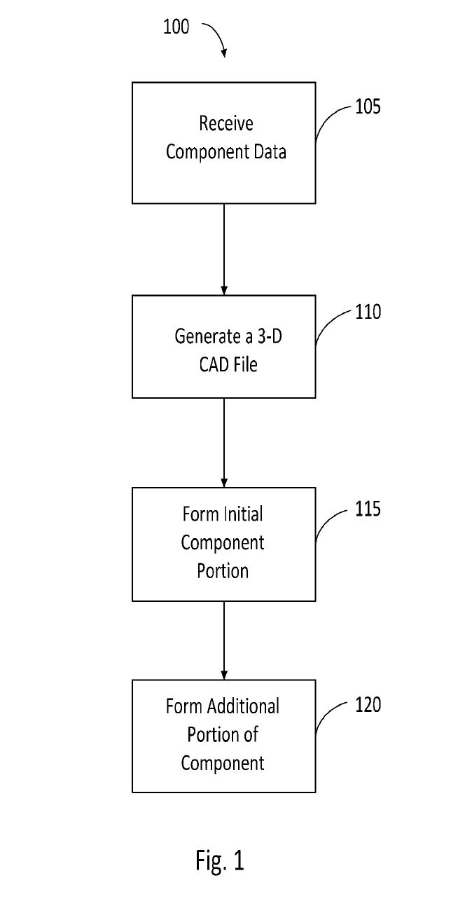

FIG. 1 depicts a method for fabricating a component according to one or more embodiments. Process 100 of FIG. 1 may be initiated by receiving data including a three-dimensional representation of a component at block 105. The three-dimensional representation may be a computer-aided design (CAD) file of the entire component. Data for the three-dimensional (3D) representation may include the outer dimensional and specifications of the component, as well as the dimensions and shape of one or more cooling passages to be formed within the component. According to one embodiment, the component includes a plurality of cooling passages.

At block 110, an electronic file, e.g., a three-dimensional computer-aided design file (3D CAD file) that contains fabrication instructions may be generated based on the received data for the three-dimensional representation of the component. IN one embodiment, data for the three-dimensional representation of the component may be represented in a particular file format, such as the .stl format. The 3D CAD file includes fabrication instructions for a portion of the component. The step of generating a 3D CAD file includes partitioning the three-dimensional representation into a plurality of layers. By way of example, each layer may correspond to a substantially planar portion (e.g., sliver) of the component. Each data file generated may be associated with a layer. While described as a layer, it should be appreciated that manufacture of the component produces a solid component having a uniform representation of material.

The 3D CAD file contains instructions associated with a predetermined thickness for each portion or section of the component. The fabrication instructions may include fabrication commands for forming layers with a thickness in a range of 20 micrometers to 70 micrometers. It should be appreciated that other layer thickness values may be employed. The 3D CAD file may be used to control fabrication of each layer.

Process 100 may continue with forming an initial portion of the component based on the 3D CAD file at block 115. Forming a portion of the component ca be performed by one or more additive metal manufacturing process like “Direct Metal Laser Sintering” (DMLS™), powder-bed manufacturing, or other additive metal fabrication techniques. In one embodiment, the component may be fabricated to include a plurality of cooling passages by using additive metal manufacturing techniques Direct Metal Laser Sintering (DMLS™). DMLS™ may allow for freeform metal fabrication/additive fabrication technology for almost any metal part, including but not limited to nickel and cobalt alloys. According to an embodiment, formation of the component may be based on a print resolution which does not melt, sinter, or weld powered metal in specific area where cooling passages are desired. By way of example, a layer resolution on the order of 20-50 microns may be employed to generate well-defined cooling passages through the component.

At block 120, an additional portion of the component may be formed based on the 3D CAD file containing fabrication instructions for the additional portion of the component. The additional portion is formed on the initial portion. According to an embodiment, a portion of at least one cooling passage of the component is formed by the initial portion and the additional portion.

According to one embodiment, the initial portion and the additional portion are formed of the same material, and each cooling passage can be an effusion cooling passage. Cooling passages may be shaped with diameters in the range of 0.5 to 1.5 millimeters. By using the additive manufacturing process, an exit portion of the cooling passage can be formed to have a wider diameter than that of other portions of the cooling passages to enhance the cooling effectiveness. The expanded diameter of the cooling holes at exit portion of the cooling holes can effectively fan or disperse the cooling flow, thereby enhancing the cooling effectiveness, which is not obtainable by conventional manufacturing techniques. Thus, the additive metal manufacturing process allows to add these small local surface features, geometries, and shapes that are not possible with conventional casting tool dies, cores, and machining techniques.

Referring to FIG. 1, process 100 includes forming additional portions, or layers, of the component to form the component in its entirety at block 120. Formation of the component may also include formation of complete cooling passages. Process 100 may be employed to form solid components, such as solid metals, composites, alloys, and coated components. Process 100 may additionally include forming a coating layer on the component. The coating layer may be a material different from the material of the additional layer.

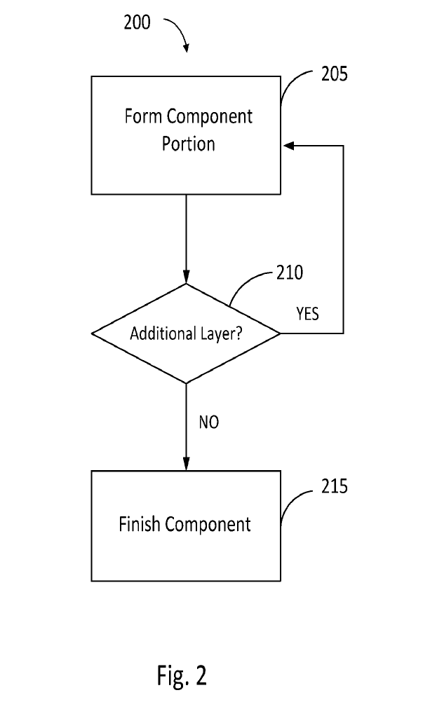

Referring now to FIG. 2, a process 200 is shown for fabricating a component according to one or more embodiments. Process 200 may relate to a process for fabricating a component with cooling passages.

Process 200 may include forming an initial portion of a component at block 205 by an additive metal manufacturing technique. The initial portion may be formed based on the 3D CAD file that includes fabricating instructions for the initial portion of the component. Process 200 may continue with forming an additional portion of the component based on the 3D CAD file that includes fabrication instructions for the additional portion of the component. The additional portion is formed onto the initial portion. According to one embodiment, a portion of at least one cooling passage of the component is formed by the initial portion and the additional portion.

According to one embodiment, a processing machine or device may determine whether additional layers should be formed at decision block 210. Additional layers may be formed by an additive metal manufacturing process to form the component with a plurality of cooling passages. Cooling passages may be formed within a plurality of layered metals with a diameter of each cooling holes in the ranges of 0.5 to 1.5 millimeters. In certain embodiments cooling passage diameter at a surface layer may be widened to enhance cooling effectiveness.

When additional layers are needed (“YES” path out of decision block 210), process 200 can form additional layers at block 205. When additional layers are not needed (“NO” path out of decision block 210), process 200 can finish forming the component at block 215. Component processing may include heat treatment or other processing step as necessary.

Process 200 may employ a DMLS™ machine having a high-powered optic laser to sinter media into a solid. Similarly, process 200 may employ a DMLS™ approach for selective fusing of materials in a granular or powder bed. Fabrication of a component as discussed herein may be inside the build chamber area having a material dispensing platform and a recoater blade to move new powder over the build platform. Fabrication may include fusing metal powder into a solid part by local melting using the focused laser beam. According to one embodiment, components may be built up additively layer by layer, using layers 20 to 50 microns thick. This process allows for highly complex geometries to be created directly from the three-dimensional data of the component within hours and without any tooling. Fabrication as used herein can produce parts with high accuracy and detailed resolution, good surface quality, and excellent mechanical properties without leaving laser slags or other structural debits.

Fabrication using DMLS™ in process 200 may allow for the ability to quickly produce a unique part with internal features and passages that could not be cast or otherwise machined. Complex geometries and assemblies with multiple components can be simplified to fewer parts with a more cost effective assembly.

According to one embodiment, process 200 may be based on downloading data files for a plurality of layers to an electron beam melting (EBM) machine to form layers in an additive manner. Process 200 may employ EBM for additive manufacturing for metal parts by melting metal powder layer by layer with an electron beam in a vacuum to build up three dimensional parts.

Process 200 may employ EMB or other freeform fabrication methods to produce fully dense metal parts directly from metal powder with desired characteristics.

According to one embodiment, layers may be melted together by a computer controlled electron beam to build up parts in a vacuum. By way of example, to perform a print, a machine may be configured to read a design from one or more data files and lay down successive layers of powder or sheet material to build the component from a series of cross sections. They layers, which may correspond to the virtual cross sections of a CAD model of the component, are joined or automatically fused to create the final shape according to one or more embodiments.

According to one embodiment, process 200 may use EBM technology to obtain the full mechanical properties of components from a pure alloy in powder form. EBM may allow for an improved build rate due to higher energy density and scanning method.

According to one embodiment, an EBM process operating at an elevated temperatures, such as between 700 and 1000° C., may be employed to produce components that are virtually free from residual stress and do not require heat treatment after the build.

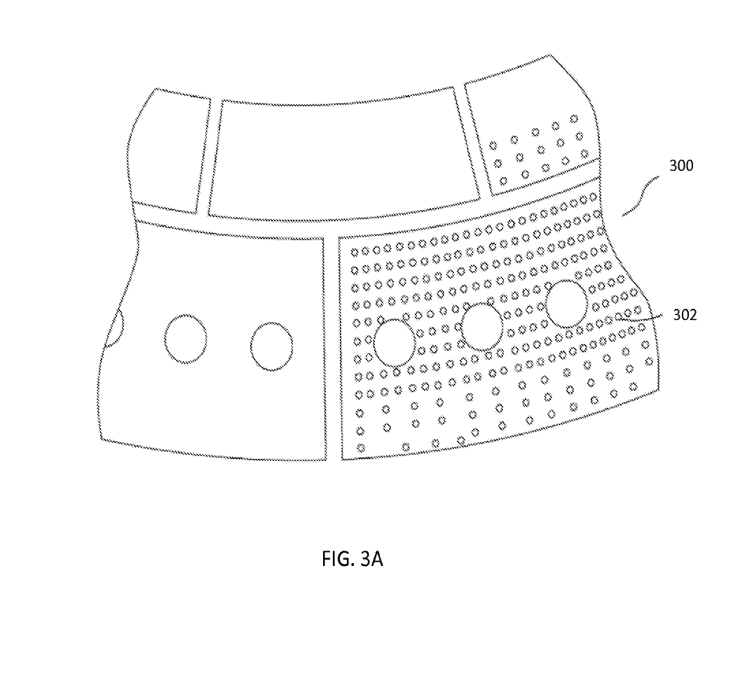

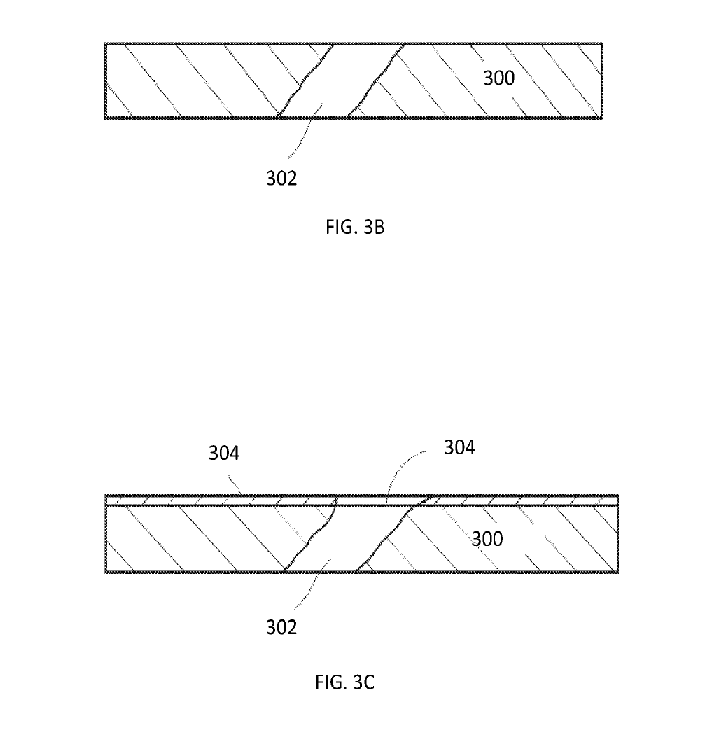

FIG. 3A depicts a graphical representation of a component according to one or more embodiments. Component 300 may be a component or part of a gas turbine or jet engine, such as an outer casing, inner panel or liner. Cooling passages 302 of component 300 may provide a thin layer of cooling air to insulate the hot side of the component from extreme temperatures. Component 300 may be fabricated by a single-walled or double-wall construction.

Component 300 may be part of a double-walled combustor in a gas turbine engine, such as one of a series of segmented panels or liners that form the inner flow path of a combustor. Components may be constructed of high-temperature alloys (e.g., nickel, cobalt) in the form of investment castings or elaborate fabrications using sheet metal.

FIGS. 3B-3C depict cross-sectional views of a component having a cooling passage 302, before and after a surface layer 304 is formed according to an one or more embodiments. In one embodiment, each cooling passage is an effusion cooling passage of the component, and each cooling passage has a diameter in a range of 0.5 to 1.5 millimeters. Cooling passages 302 may be shaped with an inclination angle and have a wider diameter at a surface layer 304 to enhance cooling effect.

According to one embodiment, the cooling passage 302 may be formed by each metal layer and shaped to have a wider diameter at the surface layer 304 to enhance cooling effectiveness. Since the shape and dimensions of the cooling holes are critical to cooling effectiveness, the cooling holes produced by additive manufacturing techniques can have more surface area and shapes so as to further improve cooling effectiveness. As illustrated in FIG. 3C, a diameter of an exit portion of the cooling holes, disposed to the surface layer 304 and formed by the additive metal manufacturing technique, may be wider than that of the cooling holes in other portions or layers of the component to increase the cooling effectiveness, according to one or more embodiments.

While this disclosure has been particularly shown and described with references to exemplary embodiments thereof, it will be understood by those skilled in the art that various changes in form and details may be made therein without departing from the scope of the claimed embodiments.

What is claimed is:

1. A method for fabricating a component with an aperture, the method comprising:
additive manufacturing initial and additional portions of the component based on data of at least one electronic file representative of the component with the initial and additional portions defining at least a portion of the aperture therethrough, wherein an exit portion of the aperture formed by the additive manufacturing has a wider diameter than that of other portions of the aperture.

2. The method of claim 1, wherein the at least one electronic file includes a three-dimensional computer-aided design (3D CAD) file of the component.

3. The method of claim 1, wherein the component is one or more of a combustor panel, a combustor liner, a combustor component, a double walled component, and a gas turbine engine component.

4. The method of claim 1, wherein the component is a solid metal component.

5. The method of claim 1, further comprising generating the at least one electronic file corresponding to the component and electronically partitioning a three-dimensional representation of the component into a plurality of layers, wherein each layer corresponds to a substantially planar portion of the component, and wherein each data file is associated with a respective layer.

6. The method of claim 1, wherein the data of the at least one electronic file includes fabrication data associated with the fabrication commands for forming layers of the component with a thickness in a range of 20 to 70 microns.

7. The method of claim 1, wherein the additive manufacturing includes one or more of a metal laser sintering, a powder-bed manufacturing, and additive metal fabrication techniques.

8. The method of claim 1, wherein the initial and additional portions are formed of the same material.

9. The method of claim 1, wherein each aperture is configured as an effusion cooling passage of the component, each cooling passage having a diameter in a range of 0.5 to 1.5 millimeters.

10. The method of claim 1, further comprising forming additional layers to form the component, wherein the initial and additional portions and the additional layers together define a plurality of cooling passages.

11. The method of claim 10, wherein each cooling passage formed in a surface layer of the component has a wider diameter than that of the cooling passages formed in other layers to increase the cooling effectiveness.

12. A method for fabricating a component with a plurality of apertures for fluid or cooling passages, the method comprising:
receiving data including a three-dimensional (3D) representation of the component;
generating a 3D computer-aided design (CAD) file based on the received data, the generated 3D CAD file includes fabrication instructions for all features of the component with the plurality of apertures;
forming an initial portion of the component by an additive metal manufacturing process based on the 3D CAD file containing fabrication instructions for the initial portion of the component;
forming an additional portion of the component by the additive metal manufacturing process based on the 3D CAD file containing fabrication instructions for the additional portion of the component, wherein the additional portion is formed on the initial portion, and
wherein a portion of at least one aperture of the component is formed by the initial portion and the additional portion and an exit portion of the aperture produced by the additive metal manufacturing process has a wider diameter than that of other portions of the aperture.

13. The method of claim 12, wherein the fabrication instructions include fabrication commands for forming layers of the component with a thickness in a range of 20 to 70 microns.

14. The method of claim 12, wherein the apertures include effusion cooling passages of the component and each cooling passage has a diameter in a range of 0.5 to 1.5 millimeters.

15. A process for fabricating a component with cooling passages, the process comprising:
forming an initial portion of a component by an additive metal manufacturing process, wherein the initial portion is formed based on a three-dimensional computer-aided design file (3D CAD file) that includes fabrication instructions for the initial portion of the component;
forming an additional portion of the component by the additive metal manufacturing process based on the 3D CAD file that includes fabrication instructions for the additional portion of the component, wherein the additional portion is formed on the initial portion, and wherein a portion of at least one cooling passage of the component is formed by the initial portion and the additional portion; and
forming additional layers by the additive metal manufacturing process to form the component based on the 3D CAD file that includes fabrication instructions for the additional layers of the component, wherein an exit portion of the cooling passages produced by the additive metal manufacturing process has a wider diameter than that of other portions of the aperture.

16. The process of claim 15, wherein forming the initial and additional portions of the component is based on the 3D CAD file that is generated from a three-dimensional representation of the component, and wherein the 3D CAD file includes fabrication instructions for each portion of the component.

17. The process of claim 15, wherein each portion of the component is formed based on the 3D CAD file generated by partitioning a three-dimensional representation of the component into a plurality of layers, and wherein each layer corresponds to a planar portion of the component.

18. A gas turbine engine component comprising a solid metal structure formed by an additive metal manufacturing process, wherein the component includes a plurality of apertures and an exit portion of the apertures produced by the additive metal manufacturing process has a wider diameter than that of other portions of the aperture.

19. The gas turbine engine component according to claim 18, wherein a diameter of each aperture is in a range of 0.5 to 1.5 millimeters.

20. The gas turbine engine component according to claim 18, wherein the component is a double walled panel.
